(19) United States
(12) Patent Application Publication
(10) Pub. No.: US 2015/0074131 A1
(43) Pub. Date: Mar. 12, 2015

(54) LEVERAGING SOCIAL TRENDS TO IDENTIFY RELEVANT CONTENT

(71) Applicant: MOBITV, Inc., Emeryville, CA (US)

(72) Inventor: Cedric Fernandez, San Ramon, CA (US)

(73) Assignee: MOBITV, Inc., Emeryville, CA (US)

(21) Appl. No.: 14/022,146

(22) Filed: Sep. 9, 2013

(51) Int. Cl. G06F 17/30

(52) U.S. Cl. CPC G06F 17/30038
USPC 707/758

(57) ABSTRACT

Techniques and mechanisms described herein facilitate the leveraging of social trends to identify relevant content. According to various embodiments, social media information may be used to identify a trending topic that is a recent topic of frequent discussion on a social network. Keywords associated with the trending topic may be used to identify media content related to the trending topic. In particular embodiments, trending topics or related content may be selected based on geographic location or an individual user's social network.

### TECHNICAL FIELD

The present disclosure relates generally to the recommendation of media content and more specifically to the recommendation of media content based on social media information.

### DESCRIPTION OF RELATED ART

Content recommendation engines may be used to predict media content items that a user may be likely to enjoy. Many content recommendation engines rely upon mathematical algorithms to compute predictive models for content recommendation. The predictive models facilitate the selection of available but unviewed content items for recommendation to the user. Such selections are often based at least in part on the user's prior viewing habits.

Social interaction is a worldwide phenomenon and many people depend on social trends for timely information. For instance, social networks such as Twitter or Google+ publish topics currently trending on their networks. These trends are generated based on algorithms that track activity by topic and aggregated by location and/or a particular user's social map. However, conventional TV services today have a very static content discovery model and do not identify content based on social trends.

### BRIEF DESCRIPTION OF THE DRAWINGS

The disclosure may best be understood by reference to the following description taken in conjunction with the accompanying drawings, which illustrate particular embodiments.

FIG. 1 shows an example of a topic identification method, performed in accordance with one or more embodiments.

FIG. 2 shows an example of a content identification method.

FIG. 3 illustrates an example of a system configured in accordance with one or more embodiments.

FIG. 4 illustrates an example of a content presentation method.

FIG. 5 illustrates one technique for generating a media segment.

FIG. 6 illustrates a method for delivering social media-based content.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular servers and content delivery mechanisms. However, it should be noted that the techniques of the present invention apply to a wide variety of different servers and content delivery mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, content such as video on demand (VOD) and live streaming video content may be identified based on social trend information. Social networks may aggregate and publish information indicating currently or recently popular topics. Such information may apply to an entire social network, a portion of a social network, a geographic region, and/or a particular user of a social network. This trending information may be collected and used to search and/or order content for one or more users. In this way, users may quickly discover live or on demand content related to currently trending topics.

### Example Embodiments

According to various embodiments, users may receive content from a content management service. The content management service may facilitate the interaction of users with various types of content services. For instance, the content management service may provide a user interface for managing and accessing content from a number of different content sources. The interface may display content received via a cable or satellite television connection, one or more on-demand-video service providers such as Netflix or Amazon, and content accessible on local or network storage locations. In addition, the interface may be used to access this content on any number of content playback devices, such as televisions, laptop computers, tablet computers, personal computers, and mobile phones.

According to various embodiments, a media content recommendation engine may include one or more algorithms or formulas for recommending content. The media content recommendation engine may, for example, compute matrix factorizations and permutations based on information such as preference and viewing history information associated with a user account. These computations may be used to match users with media content that they might be interested in viewing.

According to various embodiments, various types of information may be used as inputs to create media content recommendations for users. In some cases, a user may expressly indicate preferences regarding media content, such as by rating a media content item or indicating that a media content item is liked or disliked. In other cases, a user may implicitly indicate preferences regarding media content.

According to various embodiments, a user may be provided with content recommendations based on popular content topics. A topic is referred to as “trending” when it is popular or mentioned relatively frequently on one or more social networks, news services, or other sources of topical content. Social networks such as Twitter or Google+ publish topics currently trending on their networks. These trends may be generated based on algorithms that track activity by topic and aggregated by location and/or a particular user's social map.

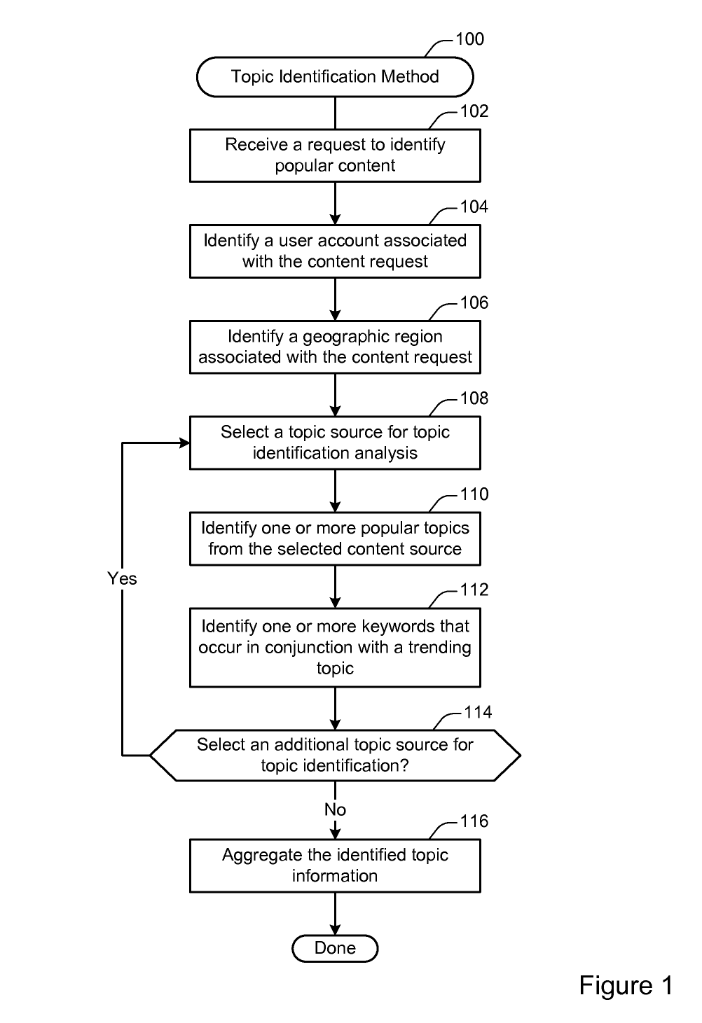

FIG. 1 shows an example of a topic identification method 100, performed in accordance with one or more embodiments. According to various embodiments, the method 100 may performed periodically, at scheduled times, or upon request. The method 100 may be used to identify topics that are trending. Topics identified in this way may be used to select content to present to a user in a user interface.

At 102, a request to identify popular content is received. According to various embodiments, the request may be received as part of a regularly scheduled routine to determine inputs to provide to a content recommendation engine. Alternately, or additionally, the request may be associated with a specific request to provide content recommendations in association with a user account in a content management system. For instance, a user associated with a user account may transmit a request to display a content guide that includes content recommendations for popular content.

At 104, a user account associated with the content request is identified. According to various embodiments, a user may be associated with a content management account in a content management system. The user account may be associated with preference information, identification information, social media information, or any other information capable of being used to identify trending topics for the user. For example, the user account may be linked to social networking accounts on one or more social networks. As another example, the user account may identify a “home” geographic location. As yet another example, the user account may specify preferences such as which types of trending topics the user would most like to view.

At 106, a geographic region associated with the content request is identified. According to various embodiments, the geographic region may be identified in any of various ways. For example, a user account may be associated with geographic information such as an indication of a user's home address. As another example, information associated with a user request may be used to infer a user's geographic location. For instance, the request may be associated with a particular Internet Service Provider (ISP), the location of which may be used to infer the user's general geographic location.

In particular embodiments, geographic region information may be identified based on information associated with a device. For example, a user may use a mobile device such as a cell phone or tablet computer to request and view content. When such a device is used, a global positioning system (GPS), cellular tower triangulation, and/or other location determination techniques may be used to identify a location associated with the mobile device. As another example, a user many use a web browser at any type of suitable computing device to request and view content. Then, a user's location or geographic area may be inferred from information such as an IP address associated with the computing device. In general, a variety of different location determination techniques are possible. The location may then be used to facilitate the selection of content relevant to a user located in a geographic region associated with the location.

At 108, a topic source is selected for topic identification analysis. According to various embodiments, selecting a topic source may involve identifying any source from which information regarding topical content may be retrieved. For example, the social networks with which a particular user has accounts may be identified. As another example, news sources that service the geographic region identified at operation 106 may be determined.

In some embodiments, a topic source may be a content discussion network. A content discussion network may be any digital environment on which content is discussed. For instance, a content discussion network may be a television news network, a radio news network, an Internet news source, a digital social network, or some other type of network.

At 110, one or more popular topics from the selected topic source may be identified. According to various embodiments, identifying popular topics may involve analyzing general social trends. For example, social networks such as Twitter or Google+ publish topics currently trending on their networks. These trends may be generated based on algorithms that track activity by topic and aggregated by location and/or a particular user's social map. Such general information may be determined by accessing APIs associated with different social networks. As another example, keywords from published news sources such as those available from news networks on the Internet may be analyzed to identify trending topics. As yet another example, crowd-sourced keywords such as those drawn from Internet searches on search engines such as Google or Yahoo may be analyzed to determine trending topics.

According to various embodiments, identifying popular topics may involve identifying topics that are trending for a particular user. For example, a user identified at operation 104 may be associated with a social network platform such as Twitter or Google+. On that social network platform, the user may be a member of a social network that includes some number of other users. Information regarding what those users are talking about on the social network platform may be collected to identify topics that may be of interest to the user.

According to various embodiments, identifying popular topics may involve identifying topics that are trending in a particular location. For instance, geographic information may be identified in operation 106. The geographic information may be used to determine more specific information from a social network, a news network, or another content source. For instance, a location-specific news source may be analyzed to identify content topics trending in a particular area. In this way, a user may be provided with content recommendations specific to the city or other geographic region in which the user is located.

At 112, one or more keywords that occur in conjunction with a trending topic are identified. According to various embodiments, keywords may be determined by selecting names for the description of a trending topic. For instance, if a newly released movie is trending, the name of the movie may be identified as a trending topic.

According to various embodiments, keywords may be identified by performing a textual analysis. For instance, some words or phrases may appear relatively infrequently in normal English but relatively frequently in text related to a trending topic. Such a word may be, for example, an actor's name, the name of a country, the name of a company, or any other word related to a current event or trending topic. For instance, the phrase “heat wave” may appear relatively infrequently in normal English but occur relatively frequently in a weather report about a heat wave affecting a particular geographic region.

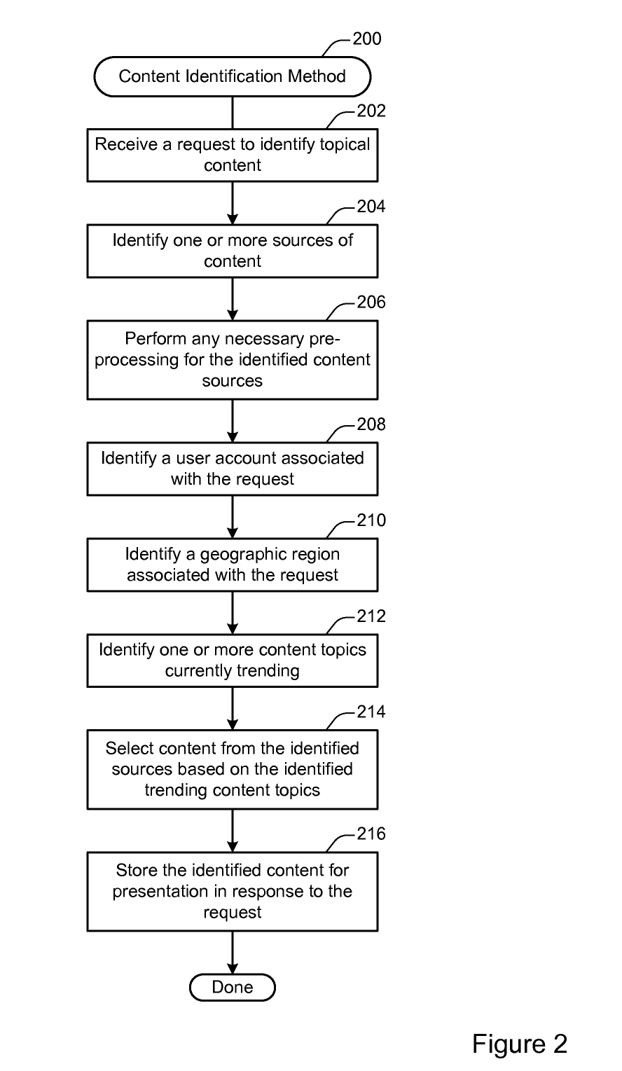

According to various embodiments, keywords may be used to identify media content items that relate to a trending topic. For instance, text such as metadata, closed caption tracks, and text versions of audio tracks associated with a media content item may be analyzed to determine whether keywords associated with trending topics are present. Techniques for identifying content items related to a trending topic are discussed in greater detail with respect to FIG. 2.

At 114, a determination may be made as to whether to select an additional topic source for analysis. According to various embodiments, the determination may be made at least in part based on how much topic information has been identified and/or how many content sources are available. For example, some users may be associated with a limited number of social networks, while other users may be associated with a greater number of social networks. As another example, in some instances a sufficient amount of topic information may be identified by analyzing a limited number of content sources, while in other instances analysis of a greater number of content sources may be indicated.

At 116, the identified topic information is aggregated. According to various embodiments, aggregating the identified topic information may involve combining topic information from different sources. For instance, topic information may be identified from different social networks or news networks. Topics that are popular across relatively more networks may be flagged as more popular than topics that are popular across relatively fewer networks.

According to various embodiments, aggregating the identified topic information may involve combining user-specific and/or location-specific topic information with general topic information. For instance, one topic may be relevant to a particular user, while another topic such as breaking news may be highly relevant to everyone. In such situations, a determination may be made as to which content to prioritize for the user.

According to various embodiments, aggregating the identified topic information may involve storing the topic information in a storage system. For instance, topic information may be stored such that it is retrievable by a content recommendation engine that is configured to provide content recommendations to users upon request. The content recommendations may be provided in the context of a content guide that provides access to media content information.

According to various embodiments, the operations shown in FIG. 1 may be performed in an order different than that shown. Alternately, or additionally, some operations may be omitted, or additional operations may be performed. For example, some popular content such as general trending topics may be determined in advance. As another example, some trending topics, such as those specific to a user or a location, may be determined on an as-needed basis. As another example, other factors may be used to determine topics relevant to a particular user, such as the user's stated preferences and/or membership in one or more social groups.

FIG. 2 shows an example of a content identification method 200. According to various embodiments, the method 200 may be used to identify content based on one or more trending topics identified via the method 100 discussed with respect to FIG. 1.

According to various embodiments, the method 200 may be performed periodically or at scheduled times. For instance, the method 200 may be performed continuously or every few minutes to identify content related to topics that are trending so that the content may be provided to viewers on a real-time or near real-time basis.

According to various embodiments, the method 200 may be performed upon request. For instance, the method 200 may be performed when a user accesses the system and requests to view media content or media content guide information.

At 202, a request to identify topical content is received. In some embodiments, the request may identify various types of information. For example, the request may identify user-specific information such as user-specific trending topics, geographic information associated with the request, or user-specific content preferences. As another example, the request may identify general information such as a set of trending topics that are likely to be of interest to many users of the system.

At 204, one or more sources of content are identified. According to various embodiments, a content source may be identified so that it may be searched for content related to topics identified as trending. Depending on the content sources available to the system, various types of content sources may be identified.

In particular embodiments, on-demand content may be identified. On-demand content includes content made available from a content library for presentation upon request. Any of a variety of different on-demand services may be used to provide the content.

In particular embodiments, the content identified may include content accessible via a content management system provided by a communications service provider and/or operator. Examples of service providers or operators may include, but are not limited to, cable companies, IP TV providers, internet service providers and mobile telephone service providers.

In particular embodiments, the content identified may include over-the-top content. Over-the-top content refers to media content delivered without a multiple system operator being involved in the control or distribution of the content itself. For instance, a service provider may provide cable television or internet access to a device which is then used to access content provided by a third party such as a media content website.

In particular embodiments, live content may be identified. Live content includes content that is streamed from a content source to subscribers. For instance, cable or broadcast television sources provide live content streams. In some instances, live content may be offered with some amount of delay. For example, a buffer of live content may be recorded and stored so that relevant live content that was recently streamed may be made available to a user in a near real-time fashion. Such a buffer may provide 10 minutes, 30 minutes, or any length of delay for real-time content. The size of the buffer may be strategically determined based on such factors as the type of content being buffered, the technical constraints of the system via which the content is provided, and the number of content streams being buffered.

At 206, any necessary pre-processing is performed for the identified content sources. For instance, the metadata associated with live content or on demand video content may not have sufficient information to help drive relevant search results. Accordingly, various types of pre-processing may be performed. According to various embodiments, pre-processing may include any operations suitable for making information related to the identified content more susceptible to searching for an indication as to whether the content relates to a trending topic.

For example, many content sources are associated with a closed caption track to provide a text version of dialogue for the hearing impaired. Such a closed caption track may be retrieved so that its text may be searched for keywords related to trending topics. As another example, many content sources are associated with an audio track that matches the video track. This audio track may be converted from spoken word to text using a speech-to-text conversion algorithm. The resulting text may then be used to perform a search for keywords related to trending topics.

At 208, a user account associated with the request is identified. In some embodiments, the user account may be identified as discussed with respect to operation 104 shown in FIG. 1. The user account may be identified so that content may be selected that is relevant to a particular user. For instance, one user may designate current events as being of particular interest, while another user may designate weather reports or celebrity gossip as being particularly relevant.

At 210, a geographic region associated with the request is identified. In some embodiments, the geographic region may be identified as discussed with respect to operation 106 shown in FIG. 1. The geographic region may be identified so that content may be selected that is relevant to a physical area in which a user or group of users is located. For instance, a group of subscribers from one region may be presented with a different set of recommended content than a group of subscribers from another region. Such geographic area-specific content may include, for example, reports of inclement weather that vary from region to region.

At 212, one or more content topics currently trending are identified. According to various embodiments, the one or more content topics may be identified as discussed with respect to the method 100 shown in FIG. 1. As discussed with respect to FIG. 1, social networks, news networks, and other venues on which current events are discussed may identify certain subjects as being topical or current.

In particular embodiments, the identification of content topics that are currently trending may involve determining one or more keywords associated with each identified topic. For instance, in 2005 the hurricane Katrina affected the Gulf Coast. If the system were to determine that such a topic were trending, then keywords such as “weather”, “hurricane”, “Katrina”, and “Gulf Coast” might be identified. These keywords may then be used to search for content related to this trending topic so that users may be quickly directed to content in which they are likely to be interested.

At 214, content from the identified sources is selected based on the identified trending content topics. According to various embodiments, identifying the content may involve searching information related to the content for keywords identified as described with respect to FIG. 1. For example, in the case of closed captions, the system will look for text in the closed captions. As another example, in the case of converted audio text, the system will look for keywords or other text in the output of the speech to text procedure. As yet another example, metadata related to content may be searched to determine a match with the trending topic keywords.

According to various embodiments, identifying the content may involve searching live content streams. For instance, the system may search the currently playing programs of all channels in the lineup to try to find a match with the selected keywords from the trending topics. The system may search content presented in the past, such as content presented during the previous ‘X’ seconds or minutes, to determine whether a live stream is related to a trending topic.

The length of time in the past in which live content is searched for topics may be strategically determined based on any of a number of factors. For example, when live content is buffered and the system can present live content delivered some period of time in the past, the length of time in the past in which live content is searched may be increased accordingly. As another example, the length of time may depend on the frequency of matches of content with topic keywords. For instance, when relatively many content streams yield a relatively close match to trending topics, the most recent matches may be favored. However, when relatively few content streams match trending topics, the length of time in the past in which live content is searched for a match may be increased. In particular embodiments, the time-sensitivity of the match may be controlled by a user and/or a system administrator.

According to various embodiments, the identification of content may be context dependent. For instance, if a trending topic relates to a celebrity actor, then the system may search all available content related to the celebrity, such as news reports and movies in which the celebrity has acted. If instead a trending topic relates to a current event such as a natural disaster or political occurrence, then the system may focus the search on content such as news reports and documentaries but ignore entertainment-related content such as movies.

At 216, the identified content is stored for presentation in response to the request. For instance, an indication of the identified content may be stored on a storage system. According to various embodiments, storing the identified content may include any of a variety of possible actions. For example, the identified content may be made available for transmission to a client machine. As another example, the identified content may be made available for retrieval by a content recommendation engine that is configured to provide content recommendations to users upon request. As yet another example, the identified content may be stored in association with a content guide that presents information related to content available on the system.

According to various embodiments, the operations shown in FIG. 2 may be performed in an order different than that shown. Alternately, or additionally, some operations may be omitted. For instance, in some cases, a geographic region or a user account may not be identified for a particular request. In such instances, topical content that is likely to be relevant to many different users may be identified.

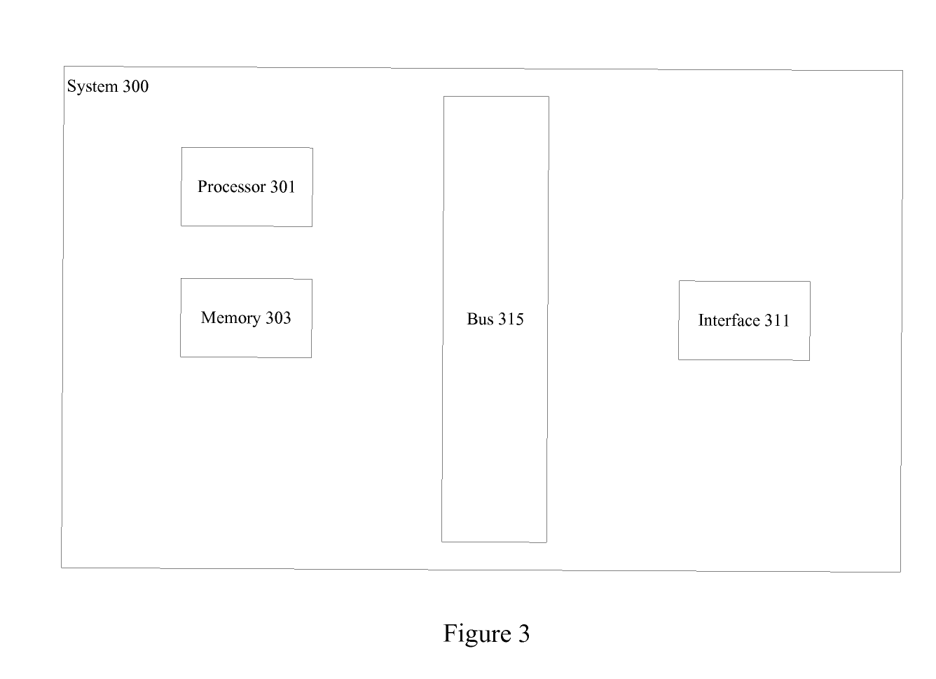

FIG. 3 illustrates one example of a server. According to particular embodiments, a system 300 suitable for implementing particular embodiments of the present invention includes a processor 301, a memory 303, an interface 311, and a bus 315 (e.g., a PCI bus or other interconnection fabric) and operates as a streaming server. When acting under the control of appropriate software or firmware, the processor 301 is responsible for modifying and transmitting live media data to a client. Various specially configured devices can also be used in place of a processor 301 or in addition to processor 301. The interface 311 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 300 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself. A variety of configurations are possible.

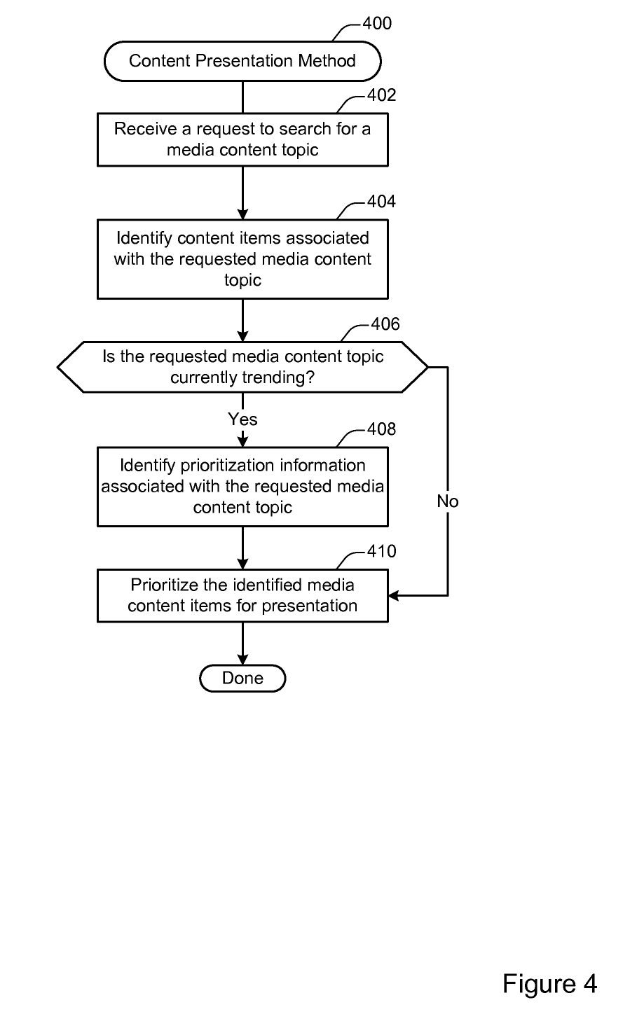

FIG. 4 illustrates an example of a content presentation method 400. According to various embodiments, the method 400 may be used to identify, aggregate, and prioritize content items. For instance, the method 400 may be used in conjunction with the methods 100 and 200 shown in FIGS. 1 and 2. The method 400 may be performed upon request, such as when a media content subscriber accesses the media system to request media content or a media content guide.

At 402, a request to search for a media content topic is received. According to various embodiments, the request may be a specific request to search for media content related to a particular media content topic. Alternately, or additionally, the request may be a general request to search for media content related to popular or trending media content topics.

In some embodiments, the request may be received from a client machine. For instance, a user at a client machine may transmit a request to browse a content guide or search for media content at a media system.

At 404, one or more content items associated with the requested media content topic are identified. In some embodiments, content items may be identified as discussed with respect to FIG. 2. For instance, trending keywords related to the topic may be identified and may be used to search a library of on-demand content and/or one or more live content streams to identify content items that are related to the requested media content topic.

In one or more embodiments, content items may be identified in some other way. For instance, information describing a library of on-demand content and/or one or more live content streams may be searched by using the requested media content topic itself. In this way, even content that is not trending may be identified.

At 406, a determination is made as to whether the requested media content topic is currently trending. According to various embodiments, the determination as to whether the media content topic is trending may be made at least in part as discussed with respect to FIG. 2. That is, one or more content discussion networks may be analyzed to determine whether the requested media content topic is a topic of recent and frequent discussion on the network.

In particular embodiments, one or more content discussion networks may be analyzed to determine any trending topics and associated keywords. For instance, as discussed with respect to operation 402, the request to search for a media content topic may be a requested to conduct a general search for trending content.

At 408, prioritization information associated with the requested media content is identified. According to various embodiments, identifying prioritization information may include determining the relevance of search results returned when content items are identified in operation 404.

In particular embodiments, prioritization information may be identified by assigning one or more scores or factors to identified content items. For example, identified content items may be rated based on how far in the past during a live stream the trending topic was discussed. As another example, a content item may be assigned a length rating that indicates the length of time during which the content item is related to the trending topic. For instance, some content items may mention a trending topic in passing, while other content items may include content that focuses on a trending topic for a longer period of time. As yet another example, a content item may be assigned a relevance rating that indicates the degree to which the content item focuses on the trending topic. For instance, one content item may infrequently mention a few keywords related to a trending topic, thus potentially indicating that the content item is somewhat related to the trending topic. At the same time, a different content item may frequently mention many keywords related to a trending topic, thus potentially indicating that the content item is highly related to the trending topic.

At 410, the identified media content items are prioritized for presentation. According to various embodiments, prioritizing the media content items may involve ordering the media content items based on the prioritization information identified at operation 408. For instance, media content items that have a relatively higher priority may be placed ahead of media content items that have a relatively lower priority.

In particular embodiments, prioritizing the media content items may involve storing a prioritized list for presentation at a client device. For instance, a prioritized list of media content items may be stored such that content items from the list may be included in a media content guide. The media content guide may be transmitted from the media system to a client device for presentation at the client device. The media content guide may describe content that is available on the media system, including content that may be trending. In this way, content items related to a trending content topic may effectively bubble up within search results and content indexes so that users accessing the media system are more likely to be presented with content that is related to topics that have been the subject of relatively recent and frequent media attention and discussion.

According to various embodiments, prioritizing the identified media content items for presentation may involve aggregating content items determined based on trending information and content items identified in other ways. For instance, a media content guide or page of search results may include some content items selected by determining content topics that are trending. At the same time, the media content guide may include some content items that are selected by some other criteria, such as presenting a live content stream that is generally popular. To prioritize between these different types of search results, the system may determine information such as a relative importance of trending content. If, for example, a particular content topic is extremely current and relevant, such as would be the case for a national election, a natural disaster, or some other event of general interest, the content items identified based on trending patterns may be prioritized. If instead few content topics are trending and no general patterns emerge, then content items selected based on other criteria may be emphasized.

In particular embodiments, search results may be presented in a timeline-based interface. In such an interface, the channels that include content that matched trending topics closest to the current time may have higher relevance than channels that include content that matched trending topics further from the current time. These channels may be further prioritized over channels with content that does not match any current trending topics.

In some embodiments, Network Digital Video Recorder (DVR) technology may be used to record live content as it is being played out by the system. Then, content that was originally delivered live may be delivered by the media system on demand.

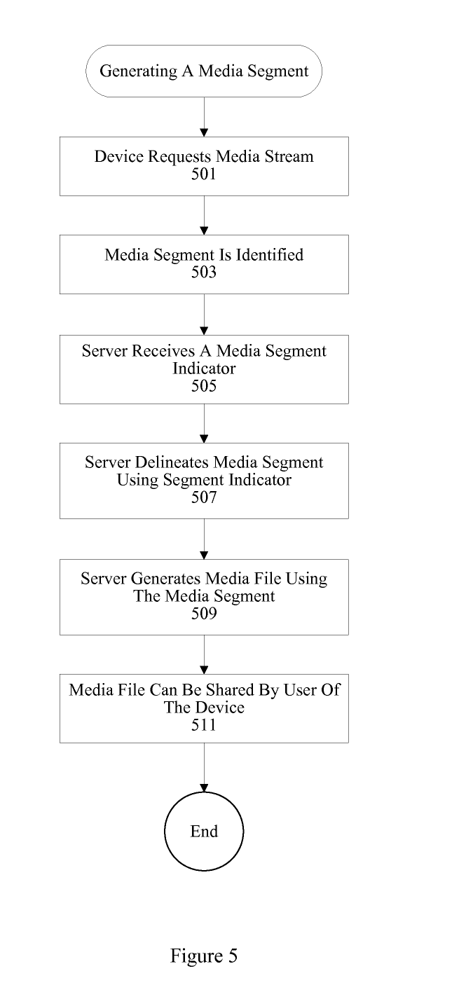

FIG. 5 illustrates a particular example of a technique for generating a media segment. According to various embodiments, a media stream is requested by a device at 501. The media stream may be a live stream, media clip, media file, etc. The request for the media stream may be an HTTP GET request with a baseurl, bit rate, and file name. At 503, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 505, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 507. The media stream may only be available in a channel buffer. At 509, the server generates a media file using the media segment maintained in cache. The media file can then be shared by a user of the device at 511. In some examples, the media file itself is shared while in other examples, a link to the media file is shared.

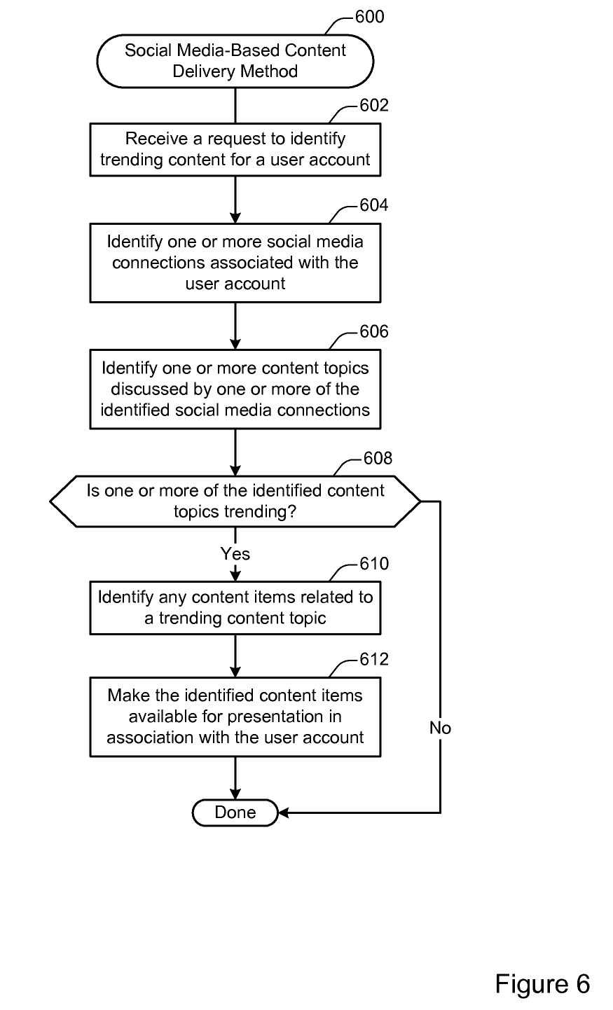

FIG. 6 illustrates a method 600 for delivering social media-based content. According to various embodiments, the method 600 may be used to provide media content recommendations based on a user's social network connections. For instance, one user of a media content management system may follow a second user such as a personal friend or a public figure on a social network. When the second user authors or re-posts a social media entry about a particular topic, the system may analyze social media trending information to determine if the topic is trending. If the topic is trending, then the system may identify media content related to the trending topic and provide the content to the user.

At 602, a request to identify trending content for a user account is received. According to various embodiments, the request may identify a particular user account in a media content management system. For example, the request may be generated when a device associated with the user account transmits a request for a content guide. As another example, the request may be generated periodically so that topical content is available to present to the user account when the user accesses the content management system.

At 604, one or more social media connections associated with the user account is identified. In some embodiments, a user account on the media content management system may be linked with an account on a social media network. The social media network may be accessed to identify the user's social media connections on that social media network. For instance, the user may “follow” or otherwise be linked with any number of other accounts on that social media network.

At 606, one or more content topics discussed by one or more of the identified social media connections are identified. In many social media networks, a user account may author a post, a comment, or a “tweet” that includes text. In some embodiments, when such a post is authored by an account to which the user account identified at operation 604 is connected, the text of the post may be analyzed to determine its subject. For instance, the post text may be analyzed to identify relatively uncommon words that may serve as keywords for identifying a trending topic. Techniques for identifying trending topics from social media text are discussed in additional detail with respect to FIG. 1.

At 608, a determination is made as to whether one or more of the identified content topics is trending. According to various embodiments, a trending topic may be identified by analyzing social media trending information to identify the presence of one or more keywords determined in operation 606. For instance, one user may follow another user who authors a post related to a particular topic. The topic may be identified based on the presence of one, two, or any number of keywords in the post. Then, social media trend information available on one or more social media networks may be analyzed to determine whether those keywords are present. The social media trend information may identify words that are recent topics of frequent discussion on the social media networks. If the keywords are present in the social media trend information, then the topic may be identified as trending.

At 610, any content items related to a trending topic are identified. In some embodiments, content items related to a trending topic may be identified by searching any information related to a content item for the presence of one or more keywords associated with a topic identified as trending. For instance, as discussed with respect to FIG. 2, the metadata, the closed caption track, or the audio track for a media content item may be analyzed to determine the presence of keywords. The audio track may be converted to text via a speech-to-text procedure to facilitate such analysis.

According to various embodiments, any content capable of being analyzed by the content management system may be identified as being related to a trending topic. For example, the content items identified as being related to a trending topic may include on-demand content items or live content items. As another example, identified content items may be provided directly by the content management system or by a third party content provider.

At 612, the identified content items are made available for presentation in association with the user account. According to various embodiments, the content items may be made available for presentation in any of various ways. For example, a description of identified content items may be included in a media content guide presented to a user accessing the content management system. As another example, content identified via trending analysis may be prioritized and/or combined with content identified in other ways, as discussed with respect to FIG. 4.

In particular embodiments, making the identified content items available for presentation may include informing the user that a topic associated with a content item is trending. For example, a user may be informed that a content item relates to a particular topic that is a recent and frequent topic of discussion on a particular social network. As another example, a user may be informed that a content item relates to topic recently mentioned by one or more of the user's social media connections.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
analyzing, via a processor, a content discussion network to identify a trending topic, the trending topic being a recent topic of frequent discussion on the content discussion network, the trending topic being associated with a plurality of trending topic keywords; and
selecting, via the processor, a media content item from a plurality of available media content items based on the trending topic keywords, the selected media content item being related to the identified trending topic.

2. The method recited in claim 1, wherein the selected media content item comprises a media content stream transmitted from a live media content source.

3. The method recited in claim 1, wherein the selected media content item comprises an on-demand media content item capable of being transmitted to a client device upon request.

4. The method recited in claim 1, the method further comprising:
identifying a closed caption track associated with the selected media content item, wherein selecting the media content item comprises searching the identified closed caption track for the identified trending topic keywords.

5. The method recited in claim 1, the method further comprising:
identifying an audio track associated with the selected media content item and converting at least a portion of the identified audio track to text, wherein selecting the media content item comprises searching the text for the identified trending topic keywords.

6. The method recited in claim 1, wherein selecting the media content item comprises identifying a geographic region associated with a content request and determining that the selected media content item is relevant to a media content subscriber in the identified geographic region.

7. The method recited in claim 1, wherein selecting the media content item comprises identifying a media subscriber account associated with a content request and determining that the selected media content item is relevant to the identified media subscriber account.

8. The method recited in claim 1, the method further comprising:
determining prioritization information for a plurality of media content items including the selected media content item, the prioritization information assigning a higher priority to a first subset of the plurality of media content items than to a second subset of the plurality of media content items, the first subset of the plurality of media content items being discussed more frequently or more recently on the content discussion network than the second subset of the plurality of media content items.

9. The method recited in claim 1, wherein the content discussion network is a network selected from the group consisting of: a television news network, a radio news network, an Internet news source, and a digital social network.

10. The method recited in claim 1, the method further comprising:
transmitting the selected media content item to a client device via a communications interface.

11. A system comprising:
a communications interface configured to receive communications from a content discussion network to identify a trending topic, the trending topic being a recent topic of frequent discussion on the content discussion network, the trending topic being associated with a plurality of trending topic keywords; and
a processor configured to select a media content item from a plurality of available media content items based on the trending topic keywords, the selected media content item being related to the identified trending topic.

12. The system recited in claim 11, wherein the selected media content item comprises a media content stream transmitted from a live media content source.

13. The system recited in claim 11, wherein the selected media content item comprises an on-demand media content item capable of being transmitted to a client device upon request.

14. The system recited in claim 11, wherein the processor is further configured to:
identify a closed caption track associated with the selected media content item, wherein selecting the media content item comprises searching the identified closed caption track for the identified trending topic keywords.

15. The system recited in claim 11, wherein the processor is further configured to:
identify an audio track associated with the selected media content item and converting at least a portion of the identified audio track to text, wherein selecting the media content item comprises searching the text for the identified trending topic keywords.

16. The system recited in claim 11, wherein selecting the media content item comprises identifying a geographic region associated with a content request and determining that the selected media content item is relevant to a media content subscriber in the identified geographic region.

17. One or more computer readable media having instructions stored thereon for performing a method, the method comprising:
analyzing, via a processor, a content discussion network to identify a trending topic, the trending topic being a recent topic of frequent discussion on the content discussion network, the trending topic being associated with a plurality of trending topic keywords; and
selecting, via the processor, a media content item from a plurality of available media content items based on the trending topic keywords, the selected media content item being related to the identified trending topic.

18. The one or more computer readable media recited in claim 17, wherein the selected media content item comprises a media content stream transmitted from a live media content source.

19. The one or more computer readable media recited in claim 17, wherein the selected media content item comprises an on-demand media content item capable of being transmitted to a client device upon request.

20. The one or more computer readable media recited in claim 17, the method further comprising:
transmitting the selected media content item to a client device via a communications interface.
